(19) United States
(12) Patent Application Publication
(10) Pub. No.: US 2022/0011432 A1
(43) Pub. Date: Jan. 13, 2022

(54) COHERENT LIDAR SYSTEM WITH IMPROVED SIGNAL-TO-NOISE RATIO

(71) Applicant: COMMISSARIAT A L'ENERGIE ATOMIQUE ET AUX ENERGIES ALTERNATIVES, PARIS (FR)

(72) Inventors: Anis DAAMI, GRENOBLE (FR); Laurent FREY, GRENOBLE (FR)

(21) Appl. No.: 17/364,143

(22) Filed: Jun. 30, 2021

(30) Foreign Application Priority Data
Jul. 10, 2020 (FR) 2007316

(51) Int. Cl. G01S 17/89; G01S 7/4911

(52) U.S. Cl. CPC G01S 17/89; G01S 7/4911

(57) ABSTRACT

A coherent lidar imaging system includes a laser source, a detection device, a first optical device, an optical imaging system, a second optical device, the photodetector component of a pixel being configured so as to generate a pixel detected signal, the pixel detected signal having an intensity, called pixel total intensity, the splitter having a variable first transmittance that is identical for all of the pixels and modulable, the second optical device furthermore comprising at least one intensity modulator designed to modulate an intensity of each pixel reference beam by applying a modulable pixel transmittance, the coherent lidar imaging system furthermore comprising a processing unit configured so as to apply a first transmittance value and, for each pixel, a pixel transmittance value, the values being determined via a control loop and using an optimization criterion, the optimization criterion comprising obtaining, for each pixel, a pixel total intensity less than a threshold intensity, and obtaining an improved signal-to-noise ratio.

### CROSS-REFERENCE TO RELATED APPLICATIONS

This application claims priority to foreign French patent application No. FR 2007316, filed on Jul. 10, 2020, the disclosure of which is incorporated by reference in its entirety.

### FIELD OF THE INVENTION

The present invention relates to the field of coherent lidar imaging, and more particularly to lidar imaging systems exhibiting improved detection.

### BACKGROUND

A coherent lidar system is an active imaging system that images a scene in 3 dimensions (distance and possibly radial velocity of the objects). This involves using a light source in order to illuminate the scene and a detector (or image sensor) having the ability to code the distance values (and/or velocity values) in order to obtain three-dimensional information from the entire observed scene. More specifically, at any coordinate point (x,y) of the scene, a velocity value v(z) and possibly a depth value P(z) are assigned thereto. This has the result of obtaining a distance z=f(x,y) and velocity v_{z}=g(x,y) map of the entire scene.

A coherent lidar system is a system in which part of the coherent illuminating light source is diverted in order to be used as an amplifier for amplifying the signal backscattered by the scene once this has been illuminated by the rest of the non-rerouted beam.

The principle of coherent lidar is well known in the prior art. Coherent lidar comprises a coherent source, typically a laser, which emits a coherent light wave (IR, visible or near-UV range), an emission device that allows a volume of space to be illuminated, and a reception device, which collects a fraction of the light wave backscattered by a target T. The Doppler frequency shift of the backscattered wave is dependent on the radial velocity v of the target T: On reception, the received backscattered light wave, called the signal wave S, of signal frequency fs, is mixed with a portion of the emitted wave that has not passed via the scene, called the LO (local oscillator) wave, and that has a local oscillator frequency f_{LO}. The interference of these two waves is detected by a photodetector PD, and the electrical signal at the output of the detector has an oscillating term called beat signal Sb, in addition to the terms proportional to the received power and to the local oscillator power. This signal is digitized and information about the velocity of the target T is extracted therefrom.

In frequency-modulated coherent lidar, called FMCW (“frequency-modulated continuous wave”) lidar, schematically shown in FIG. 1, the optical frequency of the coherent source f is modulated, typically using a periodic linear ramp.

The two paths that interfere on the photodetector produce beats, the frequency of which is proportional to the delay between the two paths, and therefore to the distance.

More specifically, for a linear ramp, the frequency of the oscillations is:

$${f}_{R} = \frac{2 B z}{cT}$$

where B is the optical frequency excursion or “chirp” over the duration T of the ramp, z is the distance and c is the speed of light.

The distance z may be deduced from the number N (N≈Tf_{R}) of periods measured over the duration T:

$$z \approx \frac{Nc}{2 B} .$$

The distance resolution is

$$δ z \approx \frac{c}{2 B} .$$

It is also possible to measure f_{R} by way of spectral analysis via Fourier transform of the beat signal.

The interference signal contains a DC component that is generally large and useless, which is removed by means of high-pass electronic filtering if the photoreceiver is a photodiode. In fibre-based setups, it is practical to use a 3 dB coupler that provides, on the basis of the two, object and reference, paths at input, two output signals in phase opposition that illuminate two photodiodes in series (balanced photodiodes). The detection circuit makes it possible to differentiate between the two photocurrents, and therefore to remove the DC (common mode) portion and to detect the AC (beat signal) portion. The AC portion is generally amplified externally by a transimpedance amplifier (TIA) before being processed by external electronics, for example an oscilloscope, in order to measure the frequency.

The FMCW lidar technique is an optical heterodyne measurement technique (that is to say it involves multiple optical frequencies). The technique is highly insensitive to stray ambient light such as for example sunlight.

To produce a complete image of the scene, according to the prior art, the lidar sequentially scans the scene using a scanning device (“rolling shutter” image).

In practice, it is difficult to achieve acquisition of distance images at video frame rates (typically 50 Hz) for high-resolution images (for example VGA or XGA) because the time available for the distance measurement at each point is very short.

Instead of taking measurements point by point, the publication Aflatouni “Nanophotonic coherent imager” (2015, Optics Express vol. 23 no. 4, 5117), which also uses the FMCW technique, describes a device in which the entire scene is illuminated simultaneously by the laser beam which has been made divergent, and photodetection is performed in parallel for the entire scene. In this publication (see FIG. 2), the laser source Las is frequency-modulated by a modulator Mod, the object path illuminates the object to be analysed O and a lens L forms the image of the object on a coherent imager IC produced with integrated optics, more specifically on a matrix array of 4×4 optical coupling gratings Res. Each grating Res sends the coupled light into a lateral-coupling photodiode PD located outside the image, via a waveguide (see FIG. 3). The reference path (local oscillator LO wave) is sent directly to the photodiodes via an optical fibre Fib and via a network of waveguides and Y-junctions. The conversion of the photocurrent into voltage is performed by a transimpedance amplifier TIA for each of the 16 photodiodes. Electronic filtering and signal processing are performed outside the chip in an electronic detection system SED.

This technique of detecting the entire scene in parallel is more suitable in principle for increasing the rate of acquisition of distance images. However, in the architecture of the imager described in the Aflatouni publication, the configuration of the coherent imager is not readily scalable to a large number of pixels. The reference beam of the local oscillator is furthermore diverted with a constant intensity once and for all and for all of the pixels of the imager. This specifically means that the amplification factor of the scene signal by the LO signal is the same for all of the pixels. In some cases, this may be detrimental if the signal returning from the scene is relatively strong. A photoreceiver is often characterized by a maximum signal level prior to saturation (called “full well”). If the signal exceeds this maximum level, there is a risk of losing information. There are some cases where multiple pixels cover different distances on the scene and are saturated. It is not possible to process all of these pixels in order to be able to retrieve distance information, given that the signal level is the same for all of them (signal=full well).

### SUMMARY OF THE INVENTION

One aim of the present invention is to rectify the abovementioned drawbacks by proposing a coherent lidar imaging system allowing the parallel acquisition of a large number of pixels and, for each pixel, improved detection in terms of managing the saturation of the photodetector and the signal-to-noise ratio.

The present invention relates to a coherent lidar imaging system comprising:

a laser source configured so as to emit laser radiation with a temporally modulated optical frequency,

a detection device comprising a matrix array of pixels, a pixel comprising a photodetector component,

a first optical device, called splitter, designed to spatially split the laser radiation into a beam, called reference beam, and into a beam, called object beam, that is directed towards a scene to be observed,

an optical imaging system having an optical axis and producing an image of the scene by imaging an object beam reflected by the scene on the pixels of the detection device, a fraction of the object beam reflected by said scene and illuminating a pixel being called pixel image beam,

a second optical device designed to route a fraction of the reference beam, called pixel reference beam, to each photodetector,

the second optical device and the optical imaging system furthermore being configured so as to superimpose, at the photodetector component of a pixel and in a substantially identical propagation direction, the pixel reference beam and the pixel image beam, forming a pixel recombined beam,
the photodetector component of a pixel being configured so as to generate a pixel detected signal from the pixel recombined beam, the pixel detected signal having an intensity, called pixel total intensity, the pixel total intensity comprising a modulated intensity and a constant intensity,
the splitter having a variable first transmittance that is identical for all of the pixels and modulable,
the second optical device furthermore comprising at least one intensity modulator designed to modulate an intensity of each pixel reference beam by applying a modulable pixel transmittance,

the coherent lidar imaging system furthermore comprising a processing unit configured so as to apply a first transmittance value and, for each pixel, a pixel transmittance value, said values being determined via a control loop and using an optimization criterion, the optimization criterion comprising obtaining, for each pixel, a pixel total intensity less than a threshold intensity, and obtaining an improved signal-to-noise ratio,

the coherent lidar imaging system furthermore being configured so as to determine, for each pixel, a beat frequency of the recombined beam.

According to one embodiment, the signal-to-noise ratio for a pixel corresponds to the ratio of the modulated intensity integrated over a given time to a square root of the total intensity integrated over the same time, the signal-to-noise ratio being determined from the signal-to-noise ratios of the pixels.

According to one embodiment, the optimization criterion furthermore comprises obtaining, for each pixel, a total intensity or a modulated intensity that is also improved.

According to one embodiment, the optimization criterion furthermore comprises obtaining a reduced dispersion of the pixel signal-to-noise ratio values.

According to a first variant, the reference beam propagates in free space, the second optical device comprising an optical recombination device, called combiner, configured so as to superimpose the reference beam and the image beam reflected by the scene,

the splitter and the second optical device being configured so as to form a virtual or real intermediate image of the reference beam in a plane perpendicular to said optical axis, called intermediate image plane, said intermediate plane being arranged so as to generate flat-tint fringes, obtained by interference, on each illuminated pixel, between the pixel reference beam and the pixel image beam,
the intensity modulator being an electrically controllable matrix component positioned on the optical path of the reference beam downstream of the splitter and upstream of the second optical device.

According to one embodiment, the second optical device furthermore comprises an intermediate optical system designed to form said intermediate image and arranged after the splitter and the matrix component and before the combiner,

the intermediate optical system in combination with the optical imaging system furthermore being arranged so as to form an image of the matrix component on the detection device.

According to one embodiment, the splitter is an electrically modulable Fabry-Perot filter.

According to one embodiment, the matrix component is a liquid-crystal modulator.

According to one embodiment, the combiner has a second modulable transmittance that is identical for all of the pixels, the processing unit furthermore being configured so as to apply a second transmittance value via said control loop and using said optimization criterion.

According to a second variant, the pixels of the detector are distributed over N columns and M rows, and at least part of the second optical device is integrated on the detector and comprises:

an optical guide, called reference guide, configured so as to receive the reference beam,

N optical guides, called column guides, coupled to the reference guide, and designed to route part of the reference beam into the N columns of the detector,

each column guide being coupled to M optical guides, called row guides, respectively associated with the M pixels of the M rows of the detector of said column, the M row guides being configured so as to route part of the reference beam into each pixel of the column,

and, in each pixel of the detector:
an optical detection guide coupled to the photodetector component,
a diffraction grating, called pixel grating, configured so as to couple the pixel image beam into the photodetector component,
a coupler, called pixel coupler, configured so as to couple the pixel image beam and the pixel reference beam into the detection guide, thus forming the recombined beam,

the second optical device comprising one integrated intensity modulator per pixel placed in series with the row guide and arranged before the pixel coupler, and at least one of the branches of which is modulable.

According to one embodiment, the integrated intensity modulator is a resonant ring.

According to one embodiment, the splitter, the second optical device and the detector are produced on the same substrate, the splitter comprising an integrated optical circuit subdividing, via a modulable Y-junction, into firstly at least one waveguide comprising at least one diffraction grating, called object grating, the at least one object grating being configured so as to decouple part of the laser beam from the plane of the integrated optical circuit so as to form the object beam, and secondly a waveguide without a grating guiding the reference beam to the detector.

According to one embodiment, the pixel coupler is a modulable directional coupler, so as to vary a ratio between the pixel reference beam and the pixel image beam, the processing unit furthermore being configured so as to apply a ratio value via said control loop and using said optimization criterion.

According to another aspect, the invention relates to a method for detecting and processing a signal from a coherent lidar imaging system, the coherent lidar imaging system comprising:

a laser source configured so as to emit laser radiation with a temporally modulated optical frequency,

a detection device comprising a matrix array of pixels, a pixel comprising a photodetector component,

a first optical device, called splitter, designed to spatially split the laser radiation into a beam, called reference beam, and into a beam, called object beam, that is directed towards the scene to be observed,

an optical imaging system having an optical axis and producing an image of the scene by imaging an object beam reflected by the scene on the pixels of the detection device, a fraction of the object beam reflected by said scene and illuminating a pixel being called pixel image beam,

a second optical device designed to route a fraction of the reference beam, called pixel reference beam, to each photodetector,

the second optical device and the optical imaging system furthermore being configured so as to superimpose, at the photodetector component of a pixel and in a substantially identical propagation direction, the pixel reference beam and the pixel image beam, forming a pixel recombined beam,
the splitter having a variable first transmittance that is identical for all of the pixels and modulable,
the second optical device furthermore comprising at least one intensity modulator designed to modulate an intensity of each pixel reference beam by applying a modulable pixel transmittance,
the method comprising the steps of:
A generating a pixel detected signal from the pixel recombined beam, the pixel detected signal having an intensity called pixel total intensity, the pixel total intensity comprising a modulated intensity and a constant intensity,
B applying a pixel transmittance value to each pixel reference beam,
C applying a first transmittance value to the reference beam,
said values being determined via a control loop and using an optimization criterion, the optimization criterion comprising, for each pixel, obtaining a pixel total intensity less than a threshold intensity and obtaining an improved signal-to-noise ratio,
D determining, for each pixel, a beat frequency of the recombined beam.

According to one embodiment, the method furthermore comprises a step C′ of applying a ratio value between the pixel reference beam and the pixel image beam, said ratio value being determined by said control loop.

The following description gives a number of exemplary embodiments of the device of the invention: these examples do not limit the scope of the invention. These exemplary embodiments not only have features that are essential to the invention but also additional features that are specific to the embodiments in question.

### BRIEF DESCRIPTION OF THE DRAWINGS

The invention will be better understood and other features, aims and advantages thereof will become apparent from the detailed description which follows and with reference to the appended drawings, which are given by way of non-limiting examples and in which:

FIG. 1, mentioned above, illustrates the principle of FMCW frequency-modulated lidar.

FIG. 2, mentioned above, illustrates a partially integrated FMCW architecture according to the prior art.

FIG. 3, mentioned above, illustrates the coherent recombination performed by the system described in FIG. 2.

FIG. 4 illustrates an architecture of a free-space lidar system.

FIG. 5 illustrates an architecture of an integrated lidar system.

FIG. 6 illustrates the lidar detector from FIG. 5.

FIG. 7 illustrates one embodiment of the lidar from the figure in which the coupling device and the integrated detector are produced on the same substrate.

FIG. 8 illustrates the detection, per pixel, of the superimposition of a pixel reference beam and a pixel image beam generating a total photon flux.

FIG. 9 illustrates certain values involved in the amount of flux collected by each photodetector in the architecture described in FIG. 4.

FIG. 10 illustrates the variant of the lidar according to the invention with the free-space propagation of the reference beam.

FIG. 11 describes an optimization algorithm implemented in a lidar according to the invention.

FIG. 12 illustrates an optimization algorithm implemented in a lidar according to the invention integrating the additional modulation of the second transmittance and the reduction in the dispersion.

FIG. 13 shows the results of optimizing the values of T1, T2 and x respectively for the pixel 1 P1, in the form of tables, in line with the procedure of optimizing the SNR under the constraint of not saturating the pixels, keeping T1 and T2 variable and considering T1=T2, and also seeking to maximize the pixel intensity.

FIG. 14 shows the results of optimizing the values of T1, T2 and x respectively for the pixel 2 P2, in the form of tables, in line with the procedure of optimizing the SNR under the constraint of not saturating the pixels, keeping T1 and T2 variable and considering T1=T2, and also seeking to maximize the pixel intensity.

FIG. 15 illustrates, in its left-hand part, the 2D trace of the signal for the pixel 1 as a function of values of T1, T2 and x(P1) and, in its right-hand part, a section along the diagonal T1=T2 of the figure from the corresponding left-hand part, in various steps a) to d) of the optimization.

FIG. 16 illustrates, in its left-hand part, the 2D trace of the signal for the pixel 1 as a function of the same values of T1, T2 and x(P1) as for FIG. 15 and, in its right-hand part, a section along the diagonal T1=T2 of the figure from the corresponding left-hand part, in various steps a) to d) of the optimization.

FIG. 17 illustrates the spectral response of the Fabry-Perot filter.

FIG. 18 illustrates one embodiment of the free-space lidar according to the invention, wherein the second optical device comprises an intermediate optical system.

FIG. 19 illustrates a lidar according to the invention having an integrated architecture.

FIG. 20 illustrates an integrated intensity modulator of Mach-Zehnder interferometer type.

FIG. 21 illustrates an integrated intensity modulator of resonant ring type.

FIG. 22 illustrates a directional coupler having a thermally modulated coupling region (lower part a)) or carrier injection-modulated coupling region (upper part b)) on one of the branches.

FIG. 23 illustrates one embodiment of the illustrated integrated lidar according to the invention in which the splitter, the second optical device and the detector are produced on the same substrate.

FIG. 24 illustrates one embodiment of the modulable junction, of evanescent-wave coupler type.

FIG. 25 illustrates an evanescent-wave coupler in which the coupling region is modulated thermally, as illustrated in FIG. 25 a), or through carrier injection (a PIN diode for example), as illustrated in FIG. 25 b).

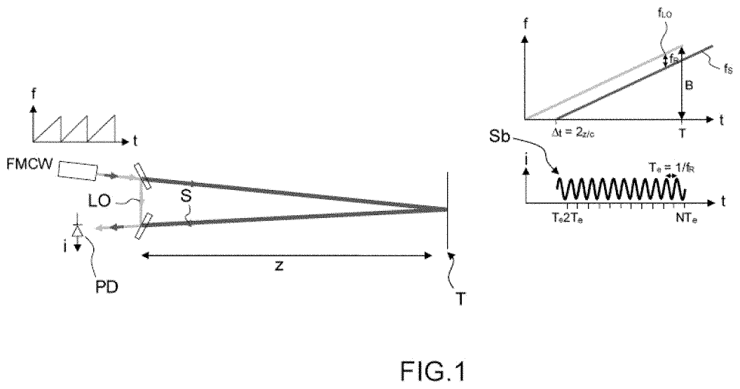

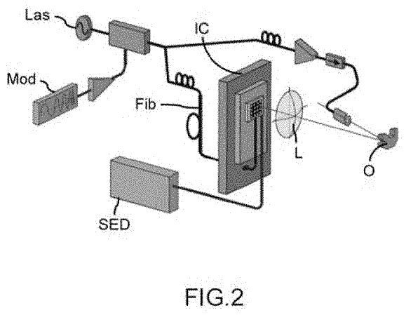

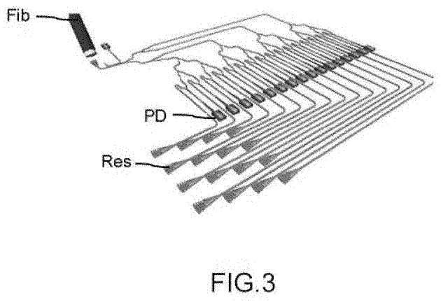

### DETAILED DESCRIPTION

The coherent lidar imaging system according to the invention is based on lidar architectures described in patent applications FR2000408 and FR2005186, not published at the filing date of the present application. These two types of coherent lidar system architecture make it possible to acquire a large number of pixels in parallel. These architectures comprise a matrix detector (or imager) in which each pixel comprises a photoreceiver. The lidar system described in document FR2000408 is based on free-space propagation of the reference beam (local oscillator) and will be called free-space lidar system, and the lidar described in document FR2005186 is based on guided optical propagation of the reference beam, and will be called integrated lidar system.

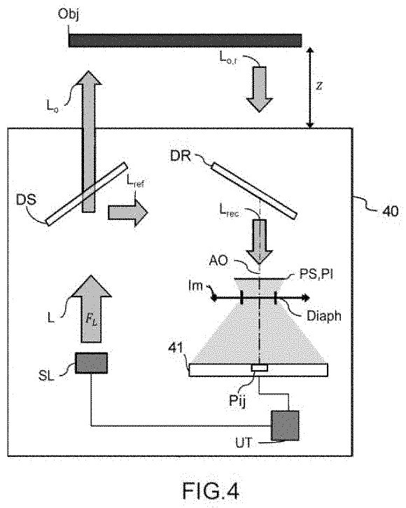

The architecture of the free-space lidar system 40 is recalled in FIG. 4. The lidar is of FMCW type and comprises a laser source SL configured so as to emit laser radiation L with a temporally modulated optical frequency FL. Preferably, the optical frequency is modulated by a periodic ramp of excursion B and of duration T, and the coherence length of the laser radiation is at least twice the maximum predetermined distance zmax between the scene to be observed Obj and the lidar 40.

The lidar 40 also comprises an optical device DS, called splitter, designed to spatially split the laser radiation L into a beam, called reference beam Lref, and into a beam, called object beam Lo, that is directed towards the scene to be observed Obj and an optical recombination device DR, called combiner, designed to spatially superimpose the reference beam Lref on the beam reflected by the scene Lo,r, so as to form a recombined beam Lrec.

The lidar 40 also comprises a matrix detection device 41 and an optical imaging system Im with an optical axis AO (diaphragm Diaph) that produces an image of the scene by imaging the beam reflected by the scene Lo,r on the detector 41. Since the scene is typically at infinity, the detector 41 is placed substantially in the focal plane of the optic Im. The matrix detector 41 comprises a matrix array of pixels Pij, each pixel comprising a photodetector component PD(i,j). The photodetector PD detects a photon flux that it transforms into an electron flux.

The optical devices DS and DR and the optical imaging system Im are configured such that each pixel Pij of the detector receives a portion of the image beam from the scene, called Lo,r/pix, and a portion of the reference beam, called Lref/pix, and that the portions are spatially superimposed coherently on each pixel. Preferably, the devices DS and DR are configured, for example with the addition of an additional optic SI (not shown), so as to convey the reference beam coherently from the laser source to an intermediate image plane PI, perpendicular to the optical axis AO of the optical imaging system Im, so as to produce a (virtual or real) coherent reference source with respect to the reflected beam. The intermediate plane PI is located close to the optical imaging system so as to generate flat-tint fringes, obtained by interference between the detected portion of the reflected beam Lo,r/pix and the detected portion of the reference beam Lref/pix on each illuminated pixel Pij. For the sake of simplicity, the beam portion illuminating a pixel is assimilated to the beam portion detected by the photodetector of this pixel. This flat-tint condition means that, on each pixel Pij, an axis of propagation of the portion Lo,r/pix of the reflected beam is collinear or substantially collinear with an axis of propagation of the portion Lref/pix of the reference beam. The devices DS, DR and SI are therefore configured so as to form a real or virtual intermediate image PS of the reference beam in the intermediate image plane PI, the plane PI being arranged so as to generate flat-tint fringes, obtained by interference between the portions, on each illuminated pixel.

The coherent lidar imaging system 40 furthermore comprises at least one electronic processing circuit configured so as to calculate, for each pixel Pij, a beat frequency F(i,j) of the portion of the image beam with the portion of the reference beam illuminating the pixel.

Lastly, the lidar 40 comprises a processing unit UT connected to the laser source and to the detector 41, and configured so as to determine a distance of points of the scene that are imaged on the pixels, on the basis of the calculated beat frequency associated with each pixel and on the basis of the modulated optical frequency of the laser radiation. The processing circuit may be located in each pixel, along a row or a column, or in the processing unit UT.

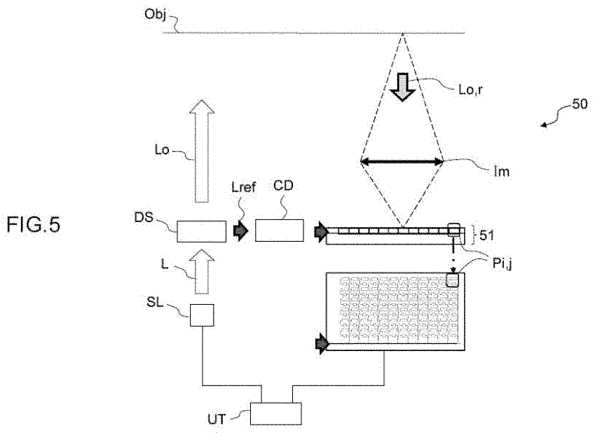

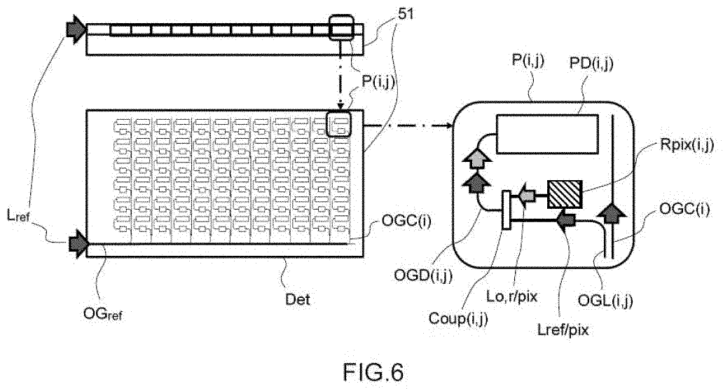

The architecture of the integrated lidar system 50 is recalled in FIG. 5. The lidar is also of FMCW type and comprises a laser source SL and a splitter device DS as described above. It also comprises a detector 51 comprising a matrix array of pixels Pij distributed over N columns (index i) and M rows (index j), different from the detector 41, and described in FIG. 6. In this case, the reference beam does not propagate in free space, but is injected directly (via a coupling device CD) into the matrix detector. The optical imaging system Im still images the scene on the detector 51 but is no longer passed through, at least partially, by the reference beam Lref.

The detector 51 comprises an optical guide, called reference guide OGref, configured so as to receive the reference beam Lref. It also comprises N optical guides OGC(i), called column guides, coupled to the reference guide OGref, and designed to route part of the reference beam into the N columns of the detector. Each column guide i is coupled to M optical guides OGL(i,j), called row guides, respectively associated with the M pixels of the M rows (indexed j) of the detector of the column i. The M row guides are configured so as to route part of the reference beam into each pixel of the column. The part of the reference beam arriving in each pixel is called pixel reference beam Lref/pix. The indices (i,j) or the index pix identically denote anything related to the pixel P(i,j). Preferably, the coupling between the reference guide OGref and the N column guides, as well as the coupling between each column guide and the M associated row guides, is evanescent. For the distribution in the N columns, the coupling coefficient is preferably provided so as to increase between the first and the last column so as to ensure similar luminous intensity in each column. The same principle may be repeated on each of the columns so as to supply the M guides associated with the M pixels in a row located along this column.

Each pixel P(i,j) of the integrated detector comprises a photodetector component PD(i,j), typically a guided photodiode, coupled to an optical detection guide OGD(i,j).

A pixel also comprises a diffraction grating, called pixel grating Rpix(i,j), configured so as to couple a portion of the beam illuminating the pixel (from the scene via the optical imaging system) into the guided photodiode PD(i,j). This portion is called pixel image beam Lo,r/pix. The pixel grating is for example a grating etched on the surface of a waveguide.

A pixel also comprises a coupler, called pixel coupler Coup(i,j), configured so as to couple the pixel image beam Lo,r/pix and the pixel reference beam Lref/pix into the detection guide OGD(i,j).

With this configuration, the guided photodiode PD(i,j) is thus configured so as to receive the pixel image beam Lo,r/pix and the pixel reference beam Lref/pix. Light is coupled into the photodiode using a conventional method, through butt coupling or through evanescent coupling. The two beams received by the photodiode interfere, as explained above.

Finally, a pixel comprises an electronic circuit for readout and for preprocessing of the signal detected by the photodiode, the preprocessing comprising amplification and filtering.

A pixel of the detector 51 thus consists of integrated optical components (guides, grating, coupler) and integrated electronic components (photodiode).

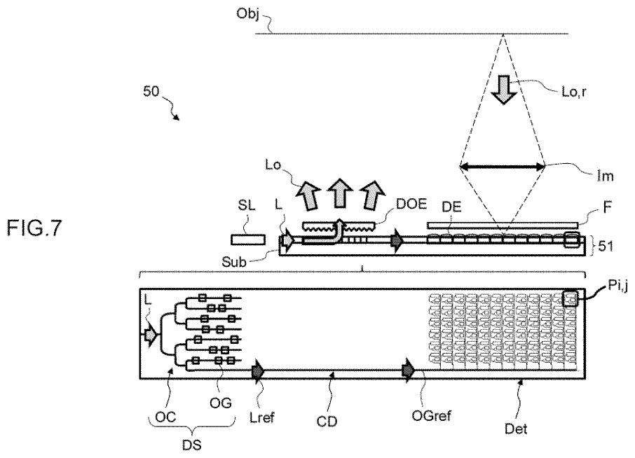

According to one embodiment of the lidar 50 illustrated in FIG. 7, the splitter device DS, the coupling device CD and the integrated detector 51 are produced on the same substrate Sub. This makes it possible to avoid flux losses linked to the transportation and coupling of the laser beam into the detector. The splitter device comprises an integrated optical circuit OC subdividing into a plurality of waveguides each comprising at least one diffraction grating, called object grating OG, the object gratings being configured so as to decouple part of the laser beam from the plane of the integrated optical circuit so as to form the object beam, and into at least one waveguide without a grating guiding the reference beam to the detector, and forming the coupling device. It is typically OGref that extends from the circuit OC to the detector.

The lidar also optionally comprises a projection system for projecting light onto a predetermined region of the scene to be observed, the image of which will subsequently be formed on the detector, therefore typically a rectangular region. Preferably, the optical projection system illuminates the scene with a cone of angular aperture that is substantially equal to the field angle of the optical imaging system (which is determined by its focal distance and the size of the detector). Thus, whatever the distance of the scene, its image corresponds to the size of the detector. The optical projection system is preferably designed to illuminate the predetermined region of the scene uniformly in order to subsequently ensure illumination and a signal-to-noise ratio that is uniform on the detector if the scene is Lambertian.

The lidar also optionally comprises a shaping optical device, for example a DOE (diffractive optical element) consisting of periodic patterns with a period of the order of the wavelength of the laser radiation, which is arranged between the circuit OC and the scene in order to allow the uniformity of the illumination to be improved.

The lidar 40 or 50 optionally comprises a filter F for intercepting stray light.

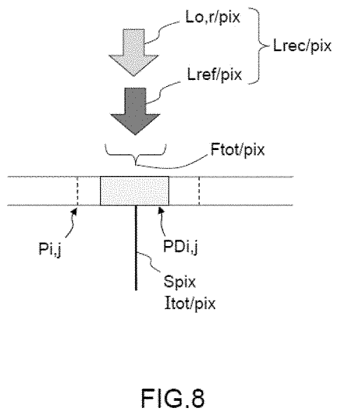

These two architectures are both based on detection, per pixel, of the superimposition of a pixel reference beam Lref/pix and a pixel image beam Lo,r/pix, generating a total photon flux F_{TOT}, as illustrated in FIG. 8. Having a local oscillator for each pixel makes it possible to have an image of each point of the scene virtually instantaneously. The respective architectures of the lidars 40 and 50 incorporating a matrix detector are thus compatible with a large number of pixels (no scanning), making it possible to produce a high-resolution lidar image. The fact that each pixel comprises its photodiode makes it possible to considerably reduce problems in terms of routing beams and in terms of bulk caused by multiple waveguides, in contrast to the Aflatouni architecture. The heterodyne mixing takes place here in each pixel.

However, in these systems 40 and 50, the reference beam of the local oscillator is always diverted with a constant intensity once and for all and for all of the pixels of the imager, thereby leading to saturation problems for some photodetectors and a signal-to-noise ratio that may be very low.

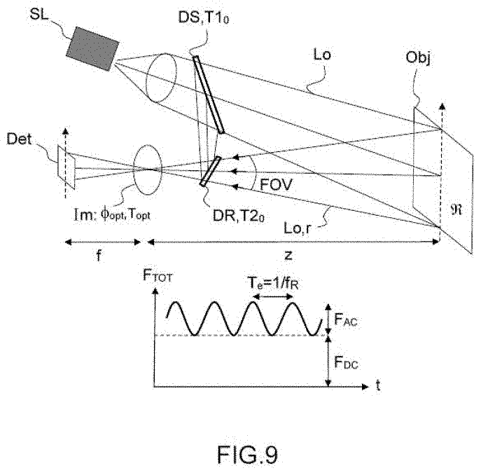

FIG. 9 illustrates certain values involved in the amount of flux collected by each photodetector in the architectures described above. The detector is denoted Det.

The total photon flux F_{TOT/pix} that reaches a photodetector PD comprises a useful component of amplitude F_{AC/pix} modulated at the frequency f_{R} as defined above and corresponding to the interference between Lref/pix and Lo,r/pix, and a constant component F_{DC/pix}. In this case:

F_{tot/pix}=F_{DC/pix}+F_{AC/pix}

Where F_{AC/pix}=F_{AC0/pix} cos²(πf_{R}t+φ)

Calculating the interference gives F_{AC/pix}∝\sqrt{ρ_{S(i,j)}ρ_{L0}}Fₜ

Fₜ is the photon flux of the laser beam before splitting into two scene and signal paths,
ρ_{S(i,j)} is the fraction of the photon flux passed through the scene path and statistically incident on a pixel of the imager,
ρ_{L0} is the fraction of the photon flux passed through the local oscillator path and statistically incident on a pixel of the imager.

Where:

$$\begin{matrix}{ρ}_{S ( i , j )} = \frac{R ( i , j ) . T {1}_{0} . T {2}_{0} . {T}_{o p c} . {∅}_{opt}^{2}}{4 NM {z ( i , j )}^{2}} & ( 1 ) \\ and & \\ {ρ}_{L 0} = \frac{( 1 - T {1}_{0} ) . ( 1 - T {2}_{0} ) . {T}_{opt}}{NM} , & ( 2 )\end{matrix}$$

where:
R(i,j) is the reflectance scattered by the scene, which depends on the point of the scene under consideration
T1₀ is the transmission of the splitter DS
T2₀ is the transmission of the combiner DR
Tₒₚₜ is the transmission of the optical imaging system Im
ϕₒₚₜ is the diameter of the pupil of the optical imaging system Im
N and M are the numbers of pixels of the imager in the directions x and y of the matrix detector

This model also applies to the integrated architecture by adapting the values of T1₀ and T2₀ to the integrated optical components. In this case, the local oscillator beam does not pass through the optic Im.

All of these values are fixed, the total intensity detected by each pixel and its useful fraction are imposed by the features of the various optical elements that form these architectures and by the experimental conditions linked to the observed scene.

In order to improve the systems described above, the lidar according to the invention incorporates an intelligent optical module acting on the reference beam Lref (local oscillator) such that each signal received by a pixel of the imager from the scene is able to be amplified individually by an adjusted local oscillator so as firstly not to saturate each photoreceiver of the imager and secondly to have the best signal-to-noise ratio SNR.

The coherent lidar imaging system according to the invention is compatible with the abovementioned two free-space and integrated architectures, and therefore comprises:
a laser source SL configured so as to emit laser radiation L with a temporally modulated optical frequency F_{L},
a detection device Det comprising a matrix array of pixels P, a pixel Pij comprising a photodetector component PD(i,j),
a first optical device, called splitter DS, designed to spatially split the laser radiation L into a beam, called reference beam L_{ref}, and into a beam, called object beam Lₒ, that is directed towards a scene to be observed Obj,
an optical imaging system Im having an optical axis AO and producing an image of the scene by imaging an object beam reflected by the scene Lo,r on the pixels of the detection device, a fraction of the object beam reflected by the scene and illuminating a pixel being called pixel image beam Lo,r/pix,
a second optical device D2 designed to route a fraction of the reference beam, called pixel reference beam Lref/pix, to each photodetector.

The second optical device D2 and the optical imaging system Im are furthermore configured so as to superimpose, at the photodetector component of a pixel and in a substantially identical propagation direction, the pixel reference beam Lref/pix and the pixel image beam Lo,r/pix, forming a pixel recombined beam Lrec/pix.

The photodetector component of a pixel transforms the photon flux into a proportional electron flux with a given quantum yield. The photodetector component is configured so as to generate a pixel detected signal Spix from the pixel recombined beam, the pixel detected signal having an intensity called pixel total intensity I_{tot/pix} (see FIG. 8). The detector has a quantum yield, and the detected electron signal is proportional to the photon flux incident on the detector. Hereinafter, the term (detected) signal and the term (total) intensity are used equivalently for a pixel.

The coherent lidar imaging system is furthermore configured so as to determine, for each pixel, a beat frequency F(i,j) of the recombined beam.

The coherent lidar imaging system 30 furthermore comprises a processing unit UT configured so as to determine, for each pixel, a distance of points of the scene that are imaged on said pixels (and where applicable a velocity) from the beat frequency associated with each pixel and from the modulated optical frequency of the laser radiation.

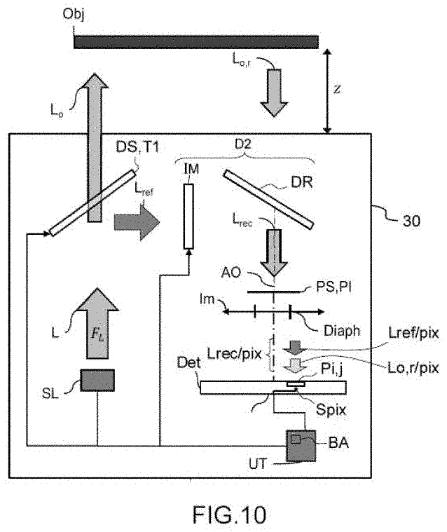

The variant of the lidar 30 according to the invention with free-space propagation of the reference beam is illustrated in FIG. 10.

In this variant, the reference beam also passes through the optic IM, which contributes to routing it to the pixels of the detector.

In the lidar according to the invention, the splitter DS of the lidar 30 of the splitter has a variable first transmittance T1 that is identical for all of the pixels and modulable. In contrast to the splitter from previous architectures, it is possible here to modify the relative ratio between the fraction of the emitted laser radiation F that forms the reference beam Lref and the fraction that illuminates the scene Lo.

For a splitter DS of splitter plate or splitter cube type, it is understood that modulation of the transmission would automatically lead to modulation of the reflection of the splitter DS, such that the sum is close to 1 (losses of this type of component are low). In this case, the transmittance T1 is preferably electrically modulable.

The second optical device D2 of the lidar 30 comprises, in addition to the combiner DR, at least one intensity modulator IM designed to modulate the intensity of each pixel reference beam Lref/pix by applying a modulable pixel transmittance. The modulator IM is an electrically controllable matrix component called SLM (for “spatial light modulator”), positioned on the optical path of the reference beam Lref downstream of the splitter DS and upstream of the combiner device DR.

The processing unit UT is configured so as to apply a first transmittance value T1 and, for each pixel, a pixel transmittance value xij, these values being determined via a control loop and using an optimization criterion. The control loop is typically implemented in the processing unit but, according to one embodiment, at least part is implemented on the detector. Parameters of the optimization are called T1 and xij, and an optimization criterion is understood to mean applying a condition to physical values. The optimization criterion comprises, for each pixel, obtaining a pixel total intensity I_{tot/pix} less than a threshold intensity Is and an improved signal-to-noise ratio SNR, which means improved in comparison with the initial value.

As illustrated below, the components for implementing the lidar 30 according to the invention are different depending on the type of architecture, but have a similar functionality. The transmission factor, and therefore the reflection factor of the splitter, are modified on the basis of the amount of backscattered light returning from the scene. The individual amplification factor is also modified for each photoreceiver of the imager by introducing a pixelated intensity modulation over the path of the local oscillator.

The intelligent optical module consists of the variable splitter DS and of the modulator IM. These two components are controlled by an electrical signal from the imager, comprising all of the detected signals Spix. The signal received by each pixel now depends on variable T1 and on the parameter xᵢⱼ, between the value 0 (no transmission) and 1 (complete transmission).

The overall transmission/reflection of the splitter is adapted, and the intensity of the local oscillator is adjusted locally for each pixel of the imager. By virtue of this and via the control, this results in not having a saturated photodetector and in having an optimum compromise between signal and SNR. T1 and xij are preferably optimized in real time in order to have the best SNR ratio while at the same time not having any saturated pixel.

The total intensity detected for a pixel I_{tot/pix} is proportional to the total photon flux Fₜₒₜ and is broken down into a modulated intensity I_{ACpix} and a constant intensity I_{DCpix} that are defined as follows:

$${I}_{A C / p i x ( i , j )} ∝ 4 \cdot \sqrt{{ρ}_{S} ( i , j ) {ρ}_{L O} ( i , j )} {F}_{t} \cdot {cos}^{2} ( π {f}_{R} t + φ ) \\ {I}_{D C / p i x ( i , j )} ∝ {( \sqrt{{ρ}_{S} ( i , j )} - \sqrt{{ρ}_{L O} ( i , j )} )}^{2} \cdot {F}_{t} \\ Where \\ ρ s ( i , j ) = \frac{ℛ ij . T 1. T {2}_{0} . {T}_{opt} {ϕ}_{opt}^{2}}{4. N . M . {z}_{ij}^{2}} \qquad ( 3 )$$

now a function of variable T1, and:

$${ρ}_{L O} ( i , j ) = \frac{{x}_{i j} \cdot ( 1 - T 1 ) \cdot ( 1 - T {2}_{0} ) \cdot {T}_{opt}}{N . M} \qquad ( 4 )$$

now a function of the pixel (i,j) and of T1.

The total intensity is defined by integrating, over a determined integration time Tint, the sum of the modulated intensity and of the constant intensity:

I_{total/pix(i,j)}=∫₀^{Tint}(I_{AC/pix(i,j)}+I_{DC/pix(i,j)})dt (5)

Preferably, and in the relatively general case in which the dominant noise is photon noise, the signal-to-noise ratio SNRₚᵢₓ for a pixel is defined as the ratio between the modulated intensity integrated over the time Tint and the square root of the total intensity integrated over the same time:

$${SNR}_{p i x ( i , j )} = \frac{{\int }_{0}^{Tint} {I}_{AC {/}_{p i x ( i , j )}} d t}{\sqrt{{I}_{total / pix ( i , j )}}} \qquad ( 6 )$$

This preferably gives:

$$Tint = \frac{Te}{N} where N \geq 3 and Te = \frac{1}{{f}_{max}}$$

with fₘₐₓ such that:

$${f}_{max} = \frac{2 B {z}_{max}}{c T}$$

zₘₐₓ being the maximum distance covered by the system.

The signal-to-noise ratio SNR of the detection used for the optimization is determined from the SNRₚᵢₓ of the pixels of the detector, and may be defined in various ways.

According to one embodiment, this is a mean signal-to-noise ratio defined as the mean of the SNRₚᵢₓ of the pixels of the detector.

SNR=<SNRₚᵢₓ>

For example, the mean is arithmetic or equal to the median.

According to another embodiment, the SNR corresponds to the minimum of the SNRₚᵢₓ and the optimization consists in increasing this minimum.

SNR=min(SNRₚᵢₓ)

Once the intensity and SNR calculations have been performed for the control, according to one option known to those skilled in the art, a processing circuit of each pixel filters the constant component and amplifies the modulated part of the detected signal.

The optimization criterion comprises two conditions:

A first condition is that I_{tot/pix}<Is for all of the pixels of the detector Det. A second condition is the increase in the SNR with respect to its initial value, under the constraint of the first condition. Various known algorithms may be used to implement the optimization, such as Newton's method or the genetic algorithm.

By seeking simply to avoid saturation while at the same time improving the SNR, it is possible, for some pixels, to obtain a relatively low total intensity or a reduced modulated intensity. In order to rectify this, the optimization criterion preferably furthermore comprises a third condition, which is that of obtaining, for each pixel, a total intensity or a modulated intensity that is also improved.

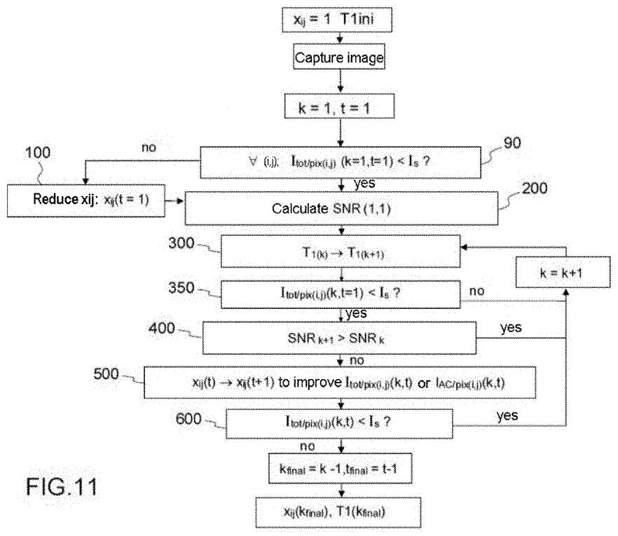

FIG. 11 shows one example of an algorithm incorporating this last condition.

xij is initialized at 1 and T1 is initialized at a value T1ini. After detecting a first image (k=1, t=1), the spatial intensity modulator IM assigns individual values xij for each pixel of the imager so as not to have any saturation in the image (steps 90 and 100). The SNR of all of the pixels SNRₚᵢₓ are calculated, and then an SNR function (mean, median, min.) dependent on these SNRₚᵢₓ is determined (step 200). The value of T1 is then adjusted so as to increase this SNR function while at the same time taking care not to cause saturation: as long as it is possible to increase SNR while at the same time not having any saturated pixel, looping back is performed (steps 300, 350 and 400 double loop on k and t).

In a step 500, it is sought locally to restore (total or modulated) intensity values by re-increasing the xij, always while remaining below saturation (step 600).

Values of xij(final) are obtained at output for all of the pixels, as well as an optimized value T1(final).

At the end of the control procedure, a final value of T1 and a matrix of values xij corresponding to each pixel Pij with the best SNR are obtained. The general philosophy of the optimization is firstly that of adjusting xij so as to avoid any saturation, and then adapting T1 so as to increase the SNR while at the same time remaining below saturation, and then, once the maximum SNR value has been obtained, locally readjusting xij so as to increase I_{tot/pix} or I_{AC/pix} when this is possible.

According to one variant of the lidar 30 according to the invention, in the free-space variant, the combiner DR also has a second modulable transmittance T2 that is identical for all of the pixels, the processing unit furthermore being configured so as to apply a second transmittance value via the control loop BA and using the optimization criterion. The transmittance T2 is preferably electrically modulable. The optimization therefore takes place via three parameters T1, T2 and xij. In this case, the formulae of ρ_{s(i,j)} and of ρ_{LO(i,j)} (3) and (4) should be modified by replacing T2₀ with variable T2.

Modulating T2 in fact modulates the relative % or ratio between the reference beam and the object beam that will recombine. Having this additional parameter in the control loop makes it possible to obtain a better optimization. Preferably, in the optimization, T2 is modified at the same time as T1.

The inventors have also demonstrated (see below) that an efficient optimization is obtained by setting T1=T2. According to this variant, which sets T1=T2, the optimization is performed again on two parameters T1=T2 and xij, thereby allowing better optimization without making the algorithm more complex.

According to one embodiment, which may be combined with the above variant, the optimization criterion furthermore comprises obtaining a reduced dispersion of the pixel signal-to-noise values. σSNR is used to define the dispersion of the SNRₚᵢₓ.

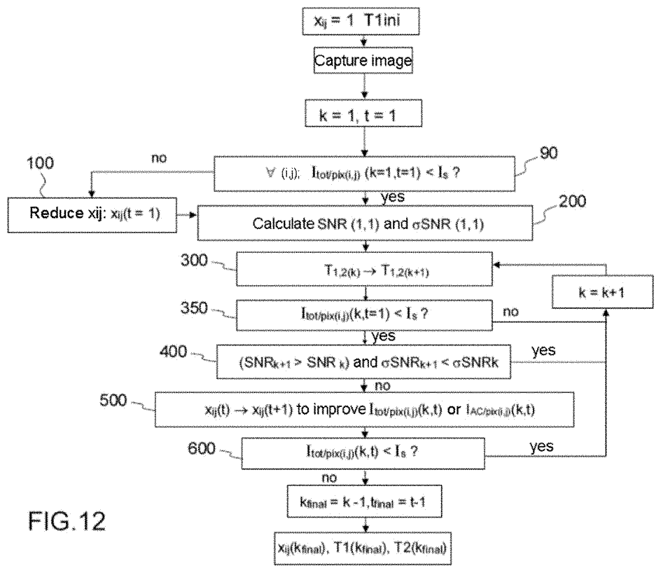

FIG. 12 illustrates one example of an optimization algorithm incorporating both the embodiment including the additional modulation of T2 and the embodiment taking into account the reduction in the dispersion. For the optimization, a weight is assigned to each of the two conditions of increasing the SNR and reducing the σSNR.

One example of an optimization on 2 pixels of an imager having a saturation level per pixel (full well) of 10⁴ electrons is presented below by way of illustration.

The first pixel P1 optically covers a distance z1=50 cm in a scene, with a reflectivity of R(P1)=0.5.

The second pixel P2 covers a distance z2=100 cm in the same scene, with a reflectivity of R(P2)=0.2.

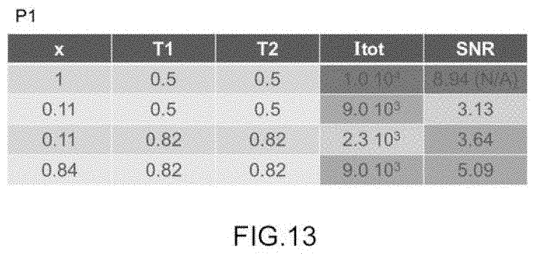

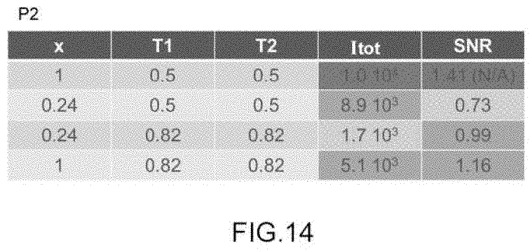

FIGS. 13 and 14 show the results of optimizing the values of T1, T2 and x respectively for the pixel 1 P1 and the pixel 2 P2, in the form of tables, in line with the procedure of optimizing the SNR under the constraint of not saturating the pixels, keeping T1 and T2 variable and considering T1=T2, and also seeking to maximize the pixel intensity.

The values of T1 and T2 are still common to the 2 pixels (see above). Initialization is performed with the parameters in the state T1=T2=0.5 and x=1 for the 2 pixels (no intensity modulation on the pixelated beam Lref/pix).

The value of the total intensity is given in number of electrons.

It is seen in the first row of the 2 tables that the signal (Itot/pix) is saturated, given that a value equal to the saturation value 10⁴ electrons is detected. This does not allow viable distance data to be recovered for the 2 pixels. The first step consists in modifying x (reducing its value) so as to lower the intensity of the beam Lref/pix for each pixel so as to bring them out of saturation.

The second row in each table shows that, for each pixel, the value of x is different (x=0.11 for P1 and x=0.24 for P2) so as to achieve an unsaturated signal value Iₜₒₜ of the same order.

Starting from this time, it is possible to determine an SNR for each pixel. Since the values of T1 and T2 are symmetrical in the equations describing the signal, their effect will be the same on the evolution of the signal and of the SNR: it is chosen to set T1=T2 and therefore to vary them in the same way.

The 3^{rd} row in each of the 2 tables shows that, for T1=T2=0.82, the SNR has been improved for each of the 2 pixels. The signal has however lost value, which is often the case when the only merit criterion is the SNR.

According to one abovementioned embodiment, a 2nd adjustment of the value of x is performed for each pixel (row 4 in the 2 tables). It is shown that this brings the value of the signal back up, while at the same time also achieving an increase in the value of the SNR. The same is observed when returning to x=1 (max value) for the pixel 2. However, it is not possible at this stage to modify the values of T1 and T2, since this would risk saturating the pixel 1, which is at a value quite close to saturation. T1 and T2 should thus be optimized for an overall return in terms of the SNR and of the (intensity) signal within the limits of non-saturation, over the whole detector. With regard to the values xᵢⱼ, these are there primarily for a local action on each pixel in order to avoid having saturated signals.

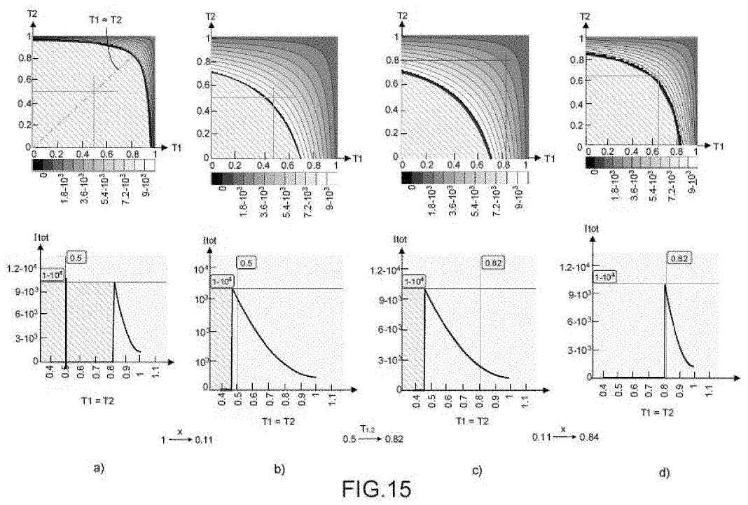

FIG. 15 illustrates the evolution of the signal for the pixel 1 P1 as a function of T1 and T2, for various steps of the optimization. The upper part of the figure for a) to d) shows the 2D trace (or “mapping”) of the signal I_{tot/pix} as a function of T1 and T2 and for a fixed value of x(P1). The lower part illustrates the section along the diagonal T1=T2. The various signal values in number of electrons are indicated by greyscale levels, the colour white corresponding to the highest level, just before saturation. For greater legibility, so as to delimit the functional region from the non-functional region on each curve, the saturation region is signalled by hatching and a value of zero is assigned to the saturated signal.

It is observed that the curves are symmetrical about the axis T1=T2, validating the choice to work on this axis for the optimization example cited above. A section along the diagonal T1=T2 is thus plotted (lower part of FIG. 15) so as to show the value of the signal Itot about this preferred axis.

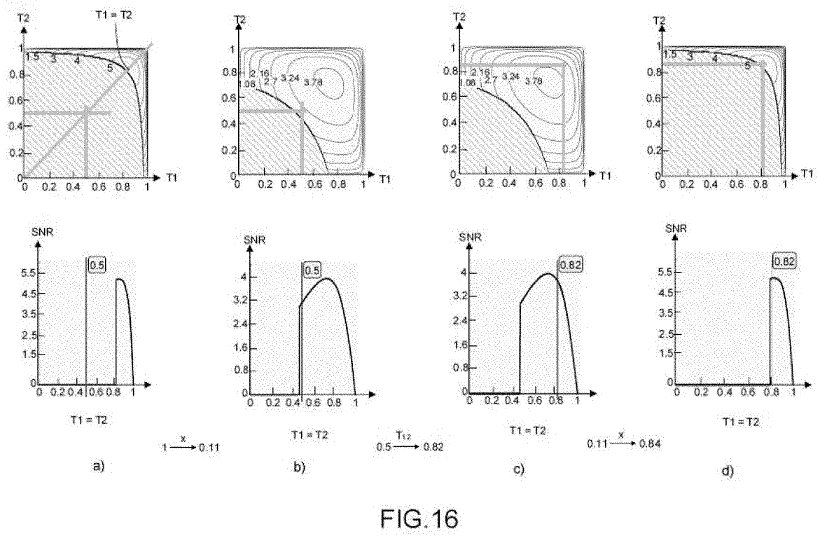

FIG. 16 illustrates the evolution of the SNR for the pixel 1 P1 as a function of T1 and T2 for the same steps of the optimization as in FIG. 15. The upper part of FIG. 16 from a) to d) illustrates the 2D trace of the SNR for the pixel 1 P1 as a function of T1 and T2 and for a value of x(P1). The various values of Iₜₒₜ in number of electrons are indicated by level curves. It is observed that the curves are also symmetrical about the axis T1=T2. A section along the diagonal T1=T2 is also plotted in the lower part of FIG. 16 so as to show the value of the SNR about this preferred axis. For greater legibility, the saturation region is signalled by hatching and a value of zero is assigned to the saturated signal.

At the start at a) (15 a) and 16 a)) for xini=1, the operating point for T1=T2=0.5 is located in the region in which the signal is saturated (hatched region).

Once the value of x has been modified from 1 to 0.11 at b), it is observed that the operating point of the signal is outside of the saturation region and is now located in the region where it is possible to calculate an SNR, here of 2.8 (see FIG. 16 b)). This is at the saturation limit, but there is some margin for improving the SNR (the highest values isoSNR located on the preferred axis, by increasing T1 and T2).

By varying T1=T2 from 0.5 to the value of 0.82 (see curves 15 c) and 16 c)), this causes the value of the SNR to slide to a higher value, here 3.6. By varying T1=T2 in this way, the operating point of the signal has also slid to lower values within the functional region (curve 1D 15 c)).

To rectify this, the non-functional range is changed so as to bring it as close as possible to the operating point T1=T2=0.82, without however saturating the signal, by acting on the value of x, which changes from 0.11 to 0.84. This makes it possible to increase the signal (see FIG. 15 d)), and it is also seen that the value of the SNR has also increased slightly to 5 (FIG. 16 d)). Ultimately, the operating point of this pixel is located at the limit of saturation (top signal value) with an optimally optimized SNR of around 5.

Thus, for the optimization, the xij are first of all reduced for the saturated pixels so as to bring them out of saturation (step 100 in FIG. 11). Next, the value of T1=T2 is increased so as to increase the SNR (steps 200+300+350+400). Finally, the values xij are readjusted so as to maximize the intensity by maintaining, or even increasing, the SNR (steps 500+600).

According to one embodiment of the free-space lidar 30 according to the invention, the matrix component is a liquid-crystal modulator LC-SLM in transmissive mode known to those skilled in the art. Each pixel is preferably controlled with circuitry often formed on the basis of TFT (thin-film transistors). This matrix component is used to pixelate the reference beam and control the intensity passing through each pixel. Of course, this component should also be optically imaged on the plane of the detector so that each pixel of the SLM corresponds to a pixel P(i,j) of the detector.

According to one embodiment of the lidar according to the invention, the splitter DS, and where applicable the combiner DR, is an electrically modulable Fabry-Perot filter. The principle of a Fabry-Perot filter is that of allowing through a light beam centred around a given wavelength λ_{filter} with a certain full width at half maximum Δλ_{filter}. Those skilled in the art are aware of modulable Fabry-Perot filters in which a voltage modulates the depth of the cavity between the Bragg gratings so as to shift the centre of the transmitted wavelength range. Use is made of a modulable filter that makes it possible to position the operating wavelength λₗₐₛₑᵣ not in the centre of the transmission curve of the filter, but on an edge of the curve of its spectral response. Modulating the filter with a voltage makes it possible to position the transmission value of the filter higher or lower on the edge for the operating wavelength λₗₐₛₑᵣ. However, one of the constraints to be complied with is that of having modulation of the wavelength of the laser far less than Δλ_{filter} so as always to remain located on the edge of the spectral response of the filter, as illustrated in FIG. 17. The three transmission curves 17, 18 and 19 are offset by applying a voltage, the voltage excursion ΔVc making it possible to vary the transmission T of the filter (and therefore its reflection) at the wavelength λₗₐₛₑᵣ by an excursion ΔT.

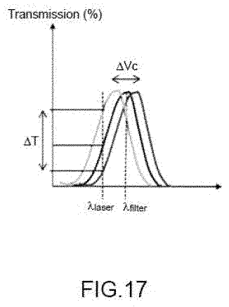

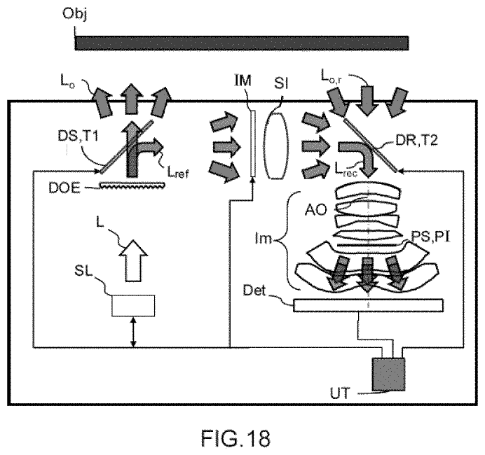

FIG. 18 illustrates one embodiment of the free-space lidar 30 according to the invention in which the second optical device D2 furthermore comprises an intermediate optical system SI designed to form the intermediate image and arranged after the splitter DS and the matrix component SLM and before the combiner DR. The intermediate optical system SI in combination with the optical imaging system Im is arranged so as to form an image of the matrix component SLM on the detection device Det.

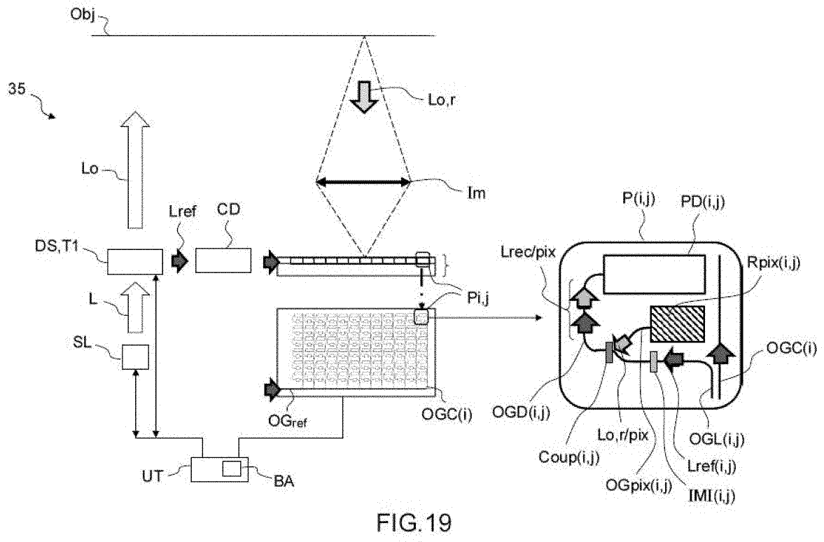

FIG. 19 illustrates a lidar 35 according to the invention having an integrated architecture.

The reference beam is injected here directly into each pixel at the detector, as illustrated in FIGS. 5 and 6. The pixels of the detector are distributed over N columns and M rows, and at least part of the second optical device D2 routing the reference beam to the photodetectors PDij is integrated on the detector Det designed in the form of integrated photonics.

The device D2 comprises an optical guide, called reference guide OGref, configured so as to receive the reference beam, and N optical guides OGC(i), called column guides, coupled to the reference guide (for example through evanescent coupling) and designed to route part of the reference beam into the N columns of the detector. Each column guide is coupled to M optical guides OGL(i,j) (for example through evanescent coupling), called row guides, respectively associated with the M pixels of the M rows of the detector of the column. The M row guides are configured so as to route part of the reference beam into each pixel of the column.

In each pixel of the detector, the device D2 comprises an optical detection guide OGD(i,j) coupled to the photodetector component PD(i,j)), a diffraction grating, called pixel grating Rpix(i,j), configured so as to couple the pixel image beam into the photodetector component, typically a guided photodiode. The diffraction grating recovers the light from the scene and couples it into a waveguide OGpix(i,j). The device D2 also comprises a coupler, called pixel coupler Coup(i,j), configured so as to couple the pixel image beam Lo,r/pix and the pixel reference beam Lref/pix into the detection guide OGD(i,j), thus forming the recombined beam Lrec/pix for the heterodyne mixing of the two beams.

The second device D2 also comprises one integrated intensity modulator per pixel IMI(i,j) placed in series with the row guide and arranged before the pixel coupler Coup(i,j), and at least one of the branches of which is modulable. The modulator IMI(i,j) is equivalent to the free-space optical pixelated SLM. The intensity modulation of each beam Lref/pix is performed locally here, in each pixel. In the architecture of FIG. 19, the splitter DS is of the same type as the lidar 30.

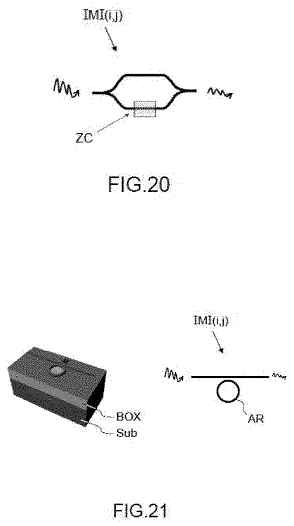

According to one embodiment, the intensity modulator IMI(i,j) is an integrated Mach-Zehnder interferometer illustrated in FIG. 20, with one of its branches having a thermally modulated or carrier injection-modulated or electro-optical modulation-modulated coupling region ZC. The activation of the thermal or electrical modulation (performed for example by a PIN diode) is controlled by the signal received by the photodiode.

According to another embodiment, the integrated intensity modulator IMI(i,j) is a resonant ring AR as illustrated in FIG. 21, for example produced on a low-index layer (for example: BOX for “buried oxide”) deposited on a high-index substrate SUB (for example: silicon), like the other guided elements (in particular the waveguides) cited in the previous paragraphs. Some of the light propagating in the waveguide is coupled into the ring AR (through evanescent coupling, the ring being located relatively close to the guide). The ring resonates at the operating wavelength, that is to say that the phase shift of the light after having made a complete revolution of the ring is a multiple of 27, such that the interference is constructive at the output of the straight waveguide between light that has not been coupled into the ring and that which has been coupled into it, made one or more revolutions, and been decoupled into the guide. The output intensity is therefore equal to the input intensity. When applying a voltage to the coupling region (located below the resonant ring), the phase shift for one revolution of the ring varies and the output intensity decreases, thus giving an intensity modulator.

According to one embodiment of the lidar 35, equivalent to the embodiment of the lidar 30 comprising modulation of the combiner DR (typically a splitter plate) by a variable transmittance T2, the modulation is performed using the pixel coupler Coup(i,j), which is a modulable directional coupler, making it possible to vary a ratio R between the pixel reference beam and the pixel image beam in the beam Lrec. The processing unit UT is then configured so as to apply a ratio value via said control loop and using the optimization criterion. A local modulation T2(i,j) is performed here, and not a global modulation as in free-space mode.

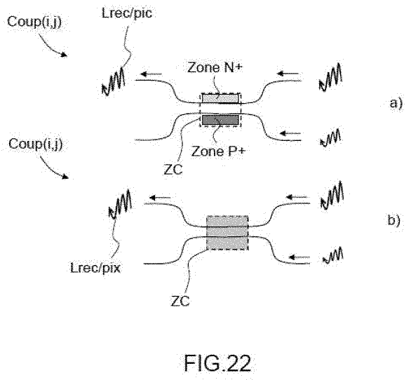

In one embodiment illustrated in FIG. 22, this 2×2 directional coupler Coup(i,j) has a thermally modulated (lower part of the figure) or carrier injection-modulated (upper part) or electro-optical modulation-modulated coupling region ZC on one of the branches. This makes it possible to vary the coupling between the 2 arms and distribute the heterodyne signal between the 2 outputs of this coupler. One of the outputs is used to carry the signal to the photodiode PD, and the other is not used, as in free-space mode in which one path of the splitter plate is not used.

According to another embodiment, the two output paths are coupled by a Y-junction so that the entire heterodyne signal is able to be guided to the photoreceiver.

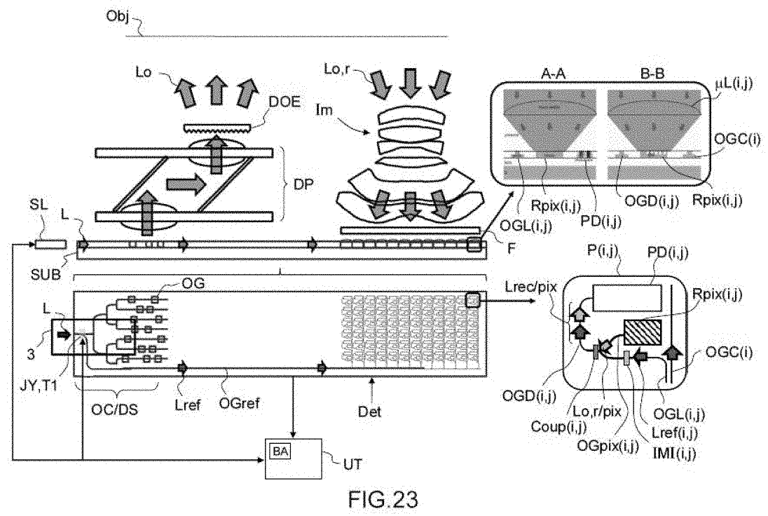

According to one embodiment of the integrated lidar 35 according to the invention illustrated in FIG. 23, the splitter DS, the second optical device D2 and the detector are produced on the same substrate Sub. The splitter DS comprises an integrated optical circuit OC subdividing, via a modulable directional coupler JY, into firstly at least one waveguide comprising at least one diffraction grating, called object grating OG, configured so as to decouple part of the laser beam from the plane of the integrated optical circuit so as to form the object beam L (via a projection device DP where applicable), and secondly a waveguide OGref without a grating guiding the reference beam to the detector. According to one option known to those skilled in the art and also illustrated in FIG. 23, the detector comprises a matrix array of microlenses μL(i,j) for focusing the object beam on the pixels Pij of the detector.

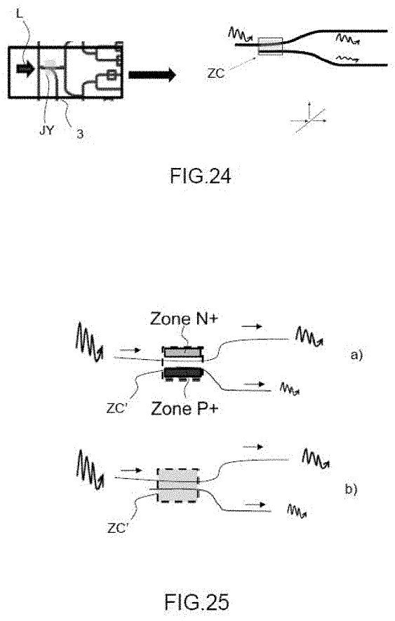

According to one embodiment, the modulable directional coupler JY is an evanescent-wave coupler. This type of coupler is illustrated in FIG. 24, which shows a zoomed-in view of the region 3 from FIG. 23. FIG. 25 illustrates two directional coupler variants. FIG. 25 b) illustrates a thermally modulated coupling region ZC′ and FIG. 25 a) illustrates a carrier injection-modulated coupling region ZC′ (a PIN diode for example). The modulation may also be electro-optical. The modulation makes it possible to vary the ratio of the beam L travelling to the diffraction grating (returning light to the scene) and the reference beam directed towards the detector. The figure below shows the principle of an evanescent-wave coupler. It should be noted that, in the examples of FIGS. 22 and 25, the couplers Coup(i,j) and JY are the same component, used either for splitting purposes or for combination purposes.

According to another aspect, the invention relates to a method for detecting and processing a signal from a coherent lidar imaging system, comprising the steps of:

A generating a pixel detected signal Spix from the pixel recombined beam, the pixel detected signal having an intensity, called pixel total intensity Itot/pix,
B applying a first transmittance value T1 to the reference beam,
C applying a pixel transmittance value xij to each pixel reference beam, the values being determined via a control loop and using an optimization criterion, the optimization criterion comprising, for each pixel, obtaining a pixel total intensity less than a threshold intensity Is and an improved signal-to-noise ratio SNR,
D determining, for each pixel, a beat frequency F(i,j) of the recombined beam.

According to one embodiment, the method according to the invention furthermore comprises a step C′ of applying a ratio value between the pixel reference beam and the pixel image beam, the ratio value being determined by the control loop.

1. A coherent lidar imaging system comprising:
a laser source (SL) configured so as to emit laser radiation (L) with a temporally modulated optical frequency (F L),
a detection device (Det) comprising a matrix array of pixels (P), a pixel (Pij) comprising a photodetector component (PD(i,j)),
a first optical device, called splitter (DS), designed to spatially split the laser radiation (L) into a beam, called reference beam (L_{ref}), and into a beam, called object beam (Lₒ), that is directed towards a scene to be observed (Obj),
an optical imaging system (Im) having an optical axis (AO) and producing an image of the scene by imaging an object beam reflected by the scene (Lo,r) on the pixels of the detection device, a fraction of the object beam reflected by said scene and illuminating a pixel being called pixel image beam (Lo,r/pix),
a second optical device (D2) designed to route a fraction of the reference beam, called pixel reference beam (Lref/pix), to each photodetector,
the second optical device (D2) and the optical imaging system (Im) furthermore being configured so as to superimpose, at the photodetector component of a pixel and in a substantially identical propagation direction, the pixel reference beam (Lref/pix) and the pixel image beam (Lo,r/pix), forming a pixel recombined beam (Lrec/pix),
the photodetector component of a pixel being configured so as to generate a pixel detected signal (Spix) from the pixel recombined beam, the pixel detected signal having an intensity, called pixel total intensity (Itot/pix), the pixel total intensity comprising a modulated intensity (I_{AC/pix}) and a constant intensity (I_{DC/pix}), the splitter having a variable first transmittance (T1) that is identical for all of the pixels and modulable,
the second optical device furthermore comprising at least one intensity modulator (IM, IMIij) designed to modulate an intensity of each pixel reference beam by applying a modulable pixel transmittance (xij),
the coherent lidar imaging system furthermore comprising a processing unit (UT) configured so as to apply a first transmittance value (T1) and, for each pixel, a pixel transmittance value (xij), said values being determined via a control loop and using an optimization criterion, the optimization criterion comprising obtaining, for each pixel, a pixel total intensity less than a threshold intensity (Is), and obtaining an improved signal-to-noise ratio (SNR),
the coherent lidar imaging system furthermore being configured so as to determine, for each pixel, a beat frequency (F(i,j)) of the recombined beam.

2. The system according to claim 1, wherein a signal-to-noise ratio for a pixel (SNRₚᵢₓ) corresponds to the ratio of the modulated intensity integrated over a given time (Tint) to a square root of the total intensity integrated over the same time, the signal-to-noise ratio (SNR) being determined from the signal-to-noise ratios of the pixels (SNRₚᵢₓ).

3. The system according to claim 2, wherein the optimization criterion furthermore comprises obtaining a reduced dispersion (σSNR) of the pixel signal-to-noise ratio values (SNRₚᵢₓ).

4. The system according to claim 1, wherein the optimization criterion furthermore comprises obtaining, for each pixel, a total intensity or a modulated intensity that is also improved.

5. The system according to claim 1, wherein the reference beam propagates in free space, the second optical device (D2) comprising an optical recombination device, called combiner (DR), configured so as to superimpose the reference beam and the image beam reflected by the scene,
the splitter and the second optical device being configured so as to form a virtual or real intermediate image (PS) of the reference beam in a plane perpendicular to said optical axis, called intermediate image plane (PI), said intermediate plane being arranged so as to generate flat-tint fringes, obtained by interference, on each illuminated pixel, between the pixel reference beam and the pixel image beam,
the intensity modulator being an electrically controllable matrix component (SLM) positioned on the optical path of the reference beam downstream of the splitter and upstream of the second optical device.

6. The system according to claim 5, wherein the second optical device furthermore comprises an intermediate optical system (SI) designed to form said intermediate image and arranged after the splitter (DS) and the matrix component (SLM) and before the combiner (DR),
the intermediate optical system (SI) in combination with the optical imaging system (Im) furthermore being arranged so as to form an image of the matrix component (SLM) on the detection device (Det).

7. The system according to claim 5, wherein the splitter is an electrically modulable Fabry-Perot filter.

8. The system according to claim 5, wherein the matrix component is a liquid-crystal modulator (LC-SLM).

9. The system according to claim 5, wherein the combiner (DR) has a second modulable transmittance that is identical for all of the pixels, the processing unit furthermore being configured so as to apply a second transmittance value (T2) via said control loop and using said optimization criterion.

10. The system according to claim 1, wherein the pixels of the detection device are distributed over N columns and M rows, and wherein at least part of the second optical device (D2) is integrated on the detection device and comprises:
an optical guide, called reference guide (OGref), configured so as to receive the reference beam,
N optical guides (OGC(i)), called column guides, coupled to the reference guide, and designed to route part of the reference beam into the N columns of the detection device,
each column guide being coupled to M optical guides (OGL(i,j)), called row guides, respectively associated with the M pixels of the M rows of the detection device of said column, the M row guides being configured so as to route part of the reference beam into each pixel of the column,
and, in each pixel (Pij) of the detection device:
an optical detection guide (OGD(i,j)) coupled to the photodetector component (PD(i,j)),
a diffraction grating, called pixel grating (Rpix(i,j)), configured so as to couple the pixel image beam into the photodetector component,
a coupler, called pixel coupler (Coup(i,j)), configured so as to couple the pixel image beam and the pixel reference beam into the detection guide, thus forming the recombined beam,
the second optical device comprising one integrated intensity modulator per pixel (IMI(i,j)) placed in series with the row guide and arranged before the pixel coupler, and at least one of the branches of which is modulable.

11. The system according to claim 10, wherein said integrated intensity modulator is a resonant ring.

12. The system according to claim 10, wherein the splitter (DS), the second optical device (D2) and the detection device are produced on the same substrate (Sub), the splitter comprising an integrated optical circuit (OC) subdividing, via a modulable Y-junction (JY), into firstly at least one waveguide comprising at least one diffraction grating, called object grating (OG), the at least one object grating being configured so as to decouple part of the laser beam from the plane of the integrated optical circuit so as to form the object beam, and secondly a waveguide without a grating guiding the reference beam to the detection device.

13. The system according to claim 10, wherein the pixel coupler is a modulable directional coupler, so as to vary a ratio (R) between the pixel reference beam and the pixel image beam, the processing unit furthermore being configured so as to apply a ratio value via said control loop and using said optimization criterion.

14. A method for detecting and processing a signal from a coherent lidar imaging system,
the coherent lidar imaging system comprising:
a laser source (SL) configured so as to emit laser radiation (L) with a temporally modulated optical frequency (F L),
a detection device (Det) comprising a matrix array of pixels (P), a pixel (Pij) comprising a photodetector component (PDij),
a first optical device, called splitter, designed to spatially split the laser radiation (L) into a beam, called reference beam (L_{ref}), and into a beam, called object beam (Lₒ), that is directed towards the scene to be observed (Obj),
an optical imaging system (Im) having an optical axis (AO) and producing an image of the scene by imaging an object beam reflected by the scene (Lo,r) on the pixels of the detection device, a fraction of the object beam reflected by said scene and illuminating a pixel being called pixel image beam (Lo,r/pix),
a second optical device (D2) designed to route a fraction of the reference beam, called pixel reference beam (Lref/pix), to each photodetector,
the second optical device (D2) and the optical imaging system (Im) furthermore being configured so as to superimpose, at the photodetector component of a pixel and in a substantially identical propagation direction, the pixel reference beam (Lref/pix) and the pixel image beam (Lo,r/pix), forming a pixel recombined beam (Lrec/pix),
the splitter having a variable first transmittance (T1) that is identical for all of the pixels and modulable,
the second optical device furthermore comprising at least one intensity modulator (IM, IMIij) designed to modulate an intensity of each pixel reference beam by applying a modulable pixel transmittance (xij),
the method comprising the steps of:
A generating a pixel detected signal (Spix) from the pixel recombined beam, the pixel detected signal having an intensity called pixel total intensity (Itot/pix),
B applying a pixel transmittance value (xij) to each pixel reference beam,
C applying a first transmittance value (T1) to the reference beam,
said values being determined via a control loop and using an optimization criterion, the optimization criterion comprising, for each pixel, obtaining a pixel total intensity less than a threshold intensity (Is) and obtaining an improved signal-to-noise ratio (SNR),
D determining, for each pixel, a beat frequency (F(i,j)) of the recombined beam.

15. The method according to claim 14, furthermore comprising a step C′ of applying a ratio value between the pixel reference beam and the pixel image beam, said ratio value being determined by said control loop.
